(19) United States
(12) Patent Application Publication
(10) Pub. No.: US 2010/0099016 A1
(43) Pub. Date: Apr. 22, 2010

(54) ELECTRONIC DEVICE

(75) Inventors: Cheng-Chung Chu, Taipei (TW); Meng-Zhang Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/564,923

(22) Filed: Sep. 23, 2009

(30) Foreign Application Priority Data
Oct. 17, 2008 (TW) 97140062

(51) Int. Cl. H01M 2/10

(52) U.S. Cl. 429/97

(57) ABSTRACT

An electronic device including a main body, a battery and a back cover is provided. The main body has a disposing space, a plurality of first terminals and a push element. The first terminals and the push element are disposed on two sides of the disposing space respectively. The battery is disposed in the disposing space. The battery has a plurality of second terminals used for contacting the first terminals. The back cover wedges the main body to cover the disposing space. The back cover has a bump on a surface toward the disposing space. During the process that the back cover is sliding along a first direction to wedge the main body, the bump pushes the push element, such that the push element pushes the battery to approach the first terminals.

### CROSS-REFERENCE TO RELATED APPLICATION

This application claims the priority benefit of Taiwan application serial no. 97140062, filed Oct. 17, 2008. The entirety of the above-mentioned patent application is hereby incorporated by reference herein and made a part of specification.

### BACKGROUND OF THE INVENTION

1. Field of the Invention

The present invention generally relates to an electronic device, in particular, to an electronic device capable of preventing from being shut down.

2. Description of Related Art

With the coming of the electronic era, all kinds of household appliances and office electric appliances get more and more popular. The electronic devices currently available in the market, such as walkman, notebook computer, palm size computer, cell phone, electronic dictionary, personal digital assistant (PDA), are all required to be equipped with a battery for power supply. In the power transmission, when the battery is placed in a battery disposing space, the purpose of power supply can be realized by the elastic sheets contacting each other. Further, the battery is generally protected by a cover to avoid the impact of external forces and prevent the battery from falling off. Thus, when the user wants to take out the battery, he/she must disassemble the battery cover on the cell phone, and then take out the battery.

In order to facilitate the user to take out the battery, a pre-foamed gap exists between the battery and the battery disposing space. However, when the preformed gap between the battery and the disposing space is too large, at the instant that the electronic device is impacted by external forces, the battery and the elastic sheets of the disposing space that contact each other are easily departed transitorily, and as a result, the cell phone is shut down. Further, the size of the gap between the battery and the battery disposing space is affected by the fabrication tolerance of the elements and the assembly tolerance of the elements.

### SUMMARY OF THE INVENTION

Accordingly, the present invention is directed to an electronic device capable of preventing from accidentally shut down due to poor contact of the battery.

The present invention provides an electronic device, which includes a main body, a battery, and a back cover. The main body has a disposing space, a plurality of first terminals, and a push element. The first terminals and the push element are located at two sides of the disposing space respectively. The battery is disposed in the disposing space. The battery has a plurality of second terminals used for contacting the first terminals. The back cover wedges the main body to cover the disposing space. The back cover has a bump on a surface towards the disposing space. During the process that the back cover is sliding along a first direction to wedge the main body, the bump pushes the push element, such that the push element pushes the battery to approach the first terminals.

In an embodiment of the present invention, the first terminals are elastic sheets.

In an embodiment of the present invention, the push element is a cantilever beam. The bump is used for contacting a free end of the cantilever beam. Further, the push element comprises a wedging bump, the battery further comprises a wedging slot corresponding to the wedging bump, and the wedging bump is disposed at, for example, a free end of the cantilever beam.

In an embodiment of the present invention, the battery approaches the first terminals along a direction vertical to the first direction.

In an embodiment of the present invention, the push element has a wedging bump. The battery further has a wedging slot corresponding to the wedging bump.

In the present invention, the bump pushes the push element, such that the push element pushes the battery to approach a terminal of the main body, so as to prevent the terminal of the battery and the terminal of the main body from being departed instantaneously and being powered off.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic exploded view of an electronic device according to an embodiment of the present invention.

FIG. 2 is a schematic cross-sectional view of the electronic device in FIG. 1 taken along a line I-I′ when a back cover does not wedge to a main body completely.

FIG. 3 is a schematic three-dimensional view of the back cover in FIG. 1 from another view angle.

FIG. 4 is a schematic cross-sectional view of the electronic device in FIG. 1 taken along the line I-I′ when the back cover wedges to the main body completely.

FIG. 5 is a schematic view of an action of the push element and the bump in FIG. 1 when an over covers the main body.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

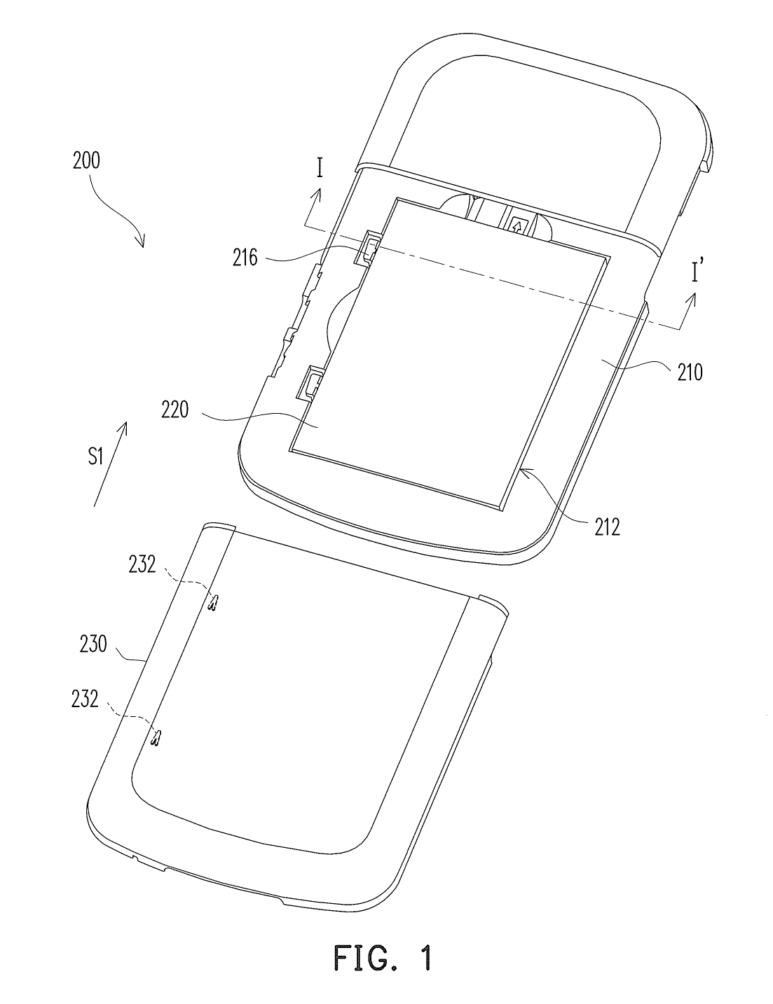

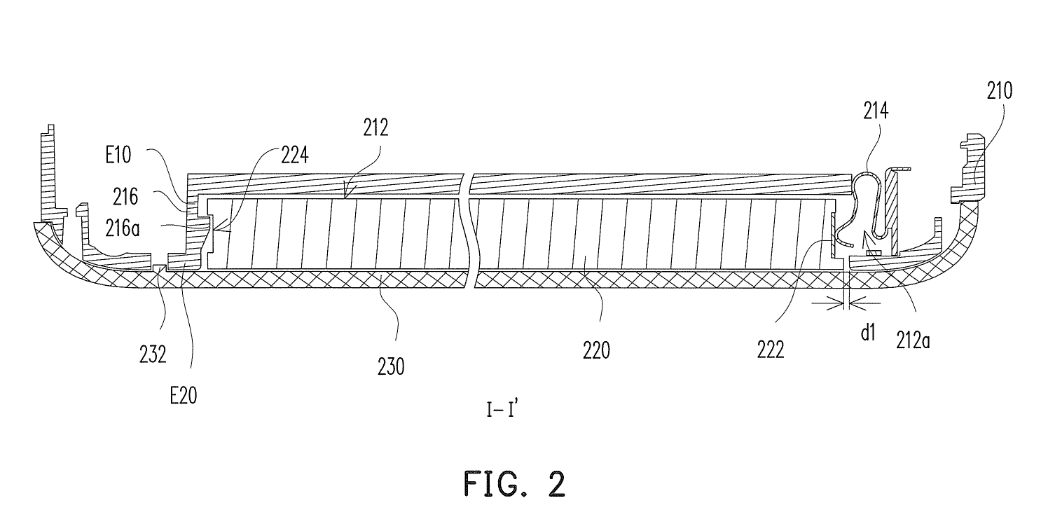

FIG. 1 is a schematic exploded view of an electronic device according to an embodiment of the present invention. FIG. 2 is a schematic cross-sectional view of the electronic device in FIG. 1 taken along a line I-I′ when a back cover does not wedge a main body completely. Referring to FIGS. 1 and 2 together, an electronic device 200 (for example, a cell phone) includes a main body 210, a battery 220, and a back cover 230. The main body 210 has a disposing space 212, a plurality of first terminals 214, and at least one push element 216 (in FIG. 1, merely two push elements 216 are exemplified). The first terminals 214 and the push elements 216 are located at two opposite sides of the disposing space 212 respectively. In this embodiment, the first terminals 214 are elastic sheets.

The disposing space 212 is used for receiving the battery 220 with a similar size. The battery 220 has a plurality of second terminals 222, and the second terminals 222 contact the first terminals 214. The disposing space 212 has at least one pre-opened slot 212a on the wall thereof, such that the first terminals 214 penetrate the slot 212a to project on the wall of the disposing space 212, so as to contact the second terminals 222 of the battery 220. At this time, the battery 220 can provide power supply to the main body 210. In this embodiment, the push element 216 and the first terminals 214 are located at two opposite sides of the disposing space 212 respectively. However, in other embodiments, the positions of the push element 216 and the first terminals 214 can be changed according to the positions of the second terminals 222.

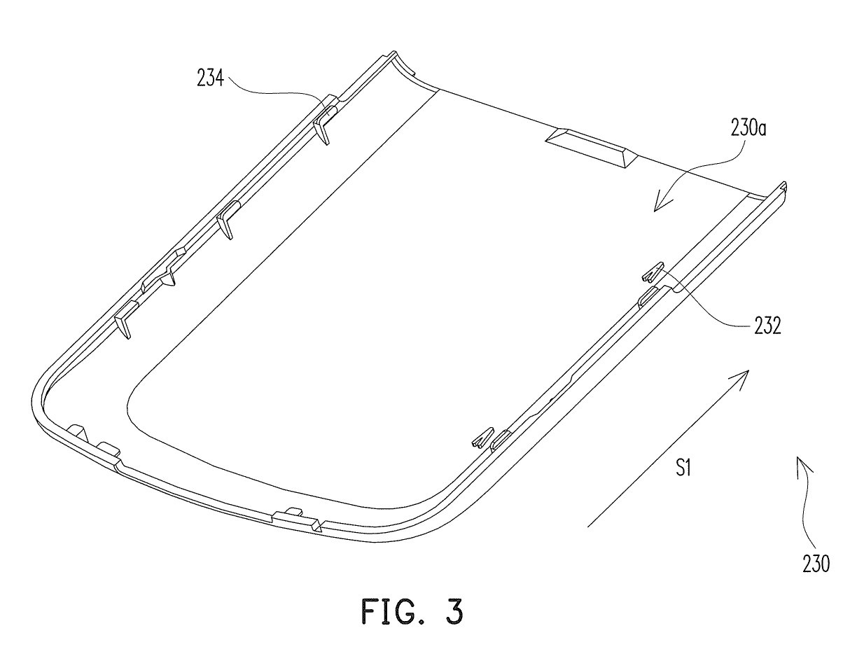

FIG. 3 is a schematic three-dimensional view of the back cover in FIG. 1 from another view angle. Referring to FIGS. 1 and 3 together, the back cover 230 wedges the main body 210 via a plurality of fasteners 234, so as to prevent the battery 220 disposed in the main body 210 from falling off. The material of the back cover 230 is, for example, plastic or other materials. The back cover 230 has at least one bump 232 (in FIG. 3, merely two bumps 232 are exemplified) on a surface 230a towards the disposing space 212. The bumps 232 are, for example, integrally formed on the back cover 230 by injection molding, and the thickness and length thereof can be appropriately adjusted according to different conditions.

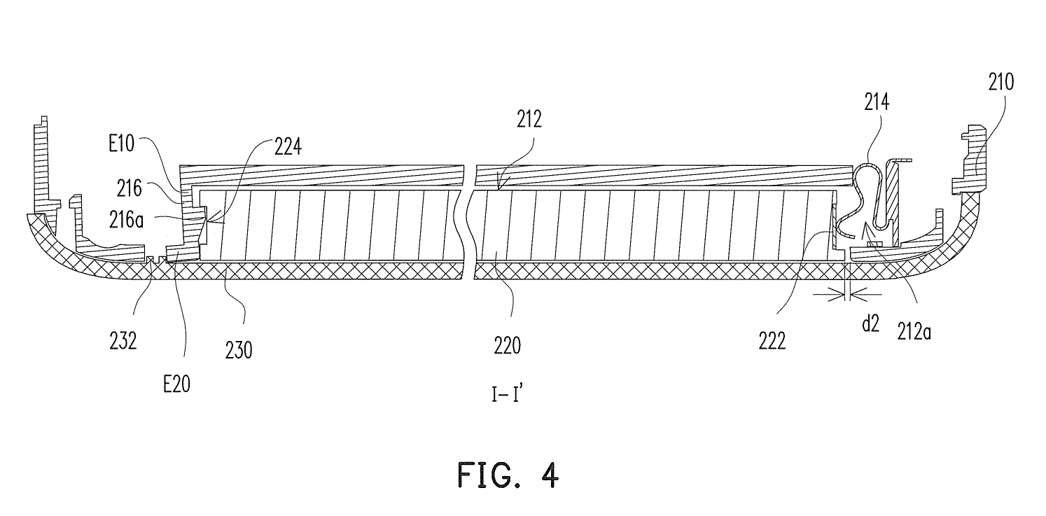

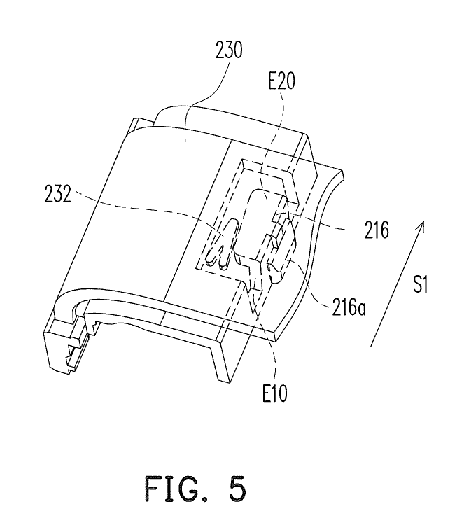

FIG. 4 is a schematic cross-sectional view of the electronic device in FIG. 1 taken along the line I-I′ when the back cover wedges the main body completely. FIG. 5 is a schematic view of an action of the push element and the bump in FIG. 1 when an over covers the main body. Referring to FIGS. 2 and 5 together, in order to facilitate the user to taken the battery 220, after the battery 220 is disposed into the disposing space 212, a first gap d1 exists there-between, and at this time, the back cover 230 does not wedge the main body 210. Next, referring to FIGS. 1, 4, and 5 together, during the process that the back cover 230 is sliding along the first direction S1 to wedge the main body 210, the bump 232 pushes the push element 216. The push element 216 pushed by the bump 232 pushes the battery 220 to approach the first terminals 214, and at this time, the battery 220 approaches the first terminals 214 along a direction vertical to the first direction S1. After the back cover 230 reaches a predetermined position and wedges the main body 210, a second gap d2 exists between the battery 220 and the disposing space 212, and the second gap d2 is smaller than the first gap d1 (as shown in FIG. 2). In other embodiments, it can also be designed that after the back cover 230 reaches the predetermined position and wedges the main body 210, the battery 220 directly contacts a wall of the disposing space 212. That is to say, the second terminals 222 of the battery 220 can tightly contact the first terminals 214 of the disposing space 212 by pushing the push element 216 with the bump 232, thus avoiding the risk that the second terminals 222 and the first terminals 214 are departed instantaneously to cause shut down when the electronic device 200 shakes under external forces or falls onto the ground.

Further, the bump 232 is, for example, a V-shaped bump, and the tip of the V-shaped bump points to the first direction S1. However, in other embodiment, the shape and the number of the bump 232 are not limited by the description of the present invention.

Referring to FIGS. 2, 3, and 5, the push element 216 is an elastic structure disposed beside the disposing space 212. The push element 216 in this embodiment is a cantilever beam and has a fixing end E10 and a free end E20 corresponding to the fixing end E10. The fixing end E10 is fixedly connected to the main body 210, and the free end E20 is movable in a certain wiggling span and has a wedging bump 216a.

The battery 220 further has a wedging slot 224 corresponding to the wedging bump 216a. The wedging slot 224 and the second terminals 222 are located at two opposite sides of the battery 220. When the battery 220 is placed into the disposing space 212, the wedging bump 216a is inset into the wedging slot 224 correspondingly, such that the battery 220 is tightly fixed in the disposing space 212. When the back cover 230 slides along the first direction S1 and covers the disposing space 212, the bump 232 contacts the free end of the push element 216.

In view of the above, in the electronic device of the present invention, the bump of the back cover pushes the push element, such that the push element pushes the battery to approach and tightly contact the first terminals. Therefore, the second terminals of the battery and the first terminals of the main body are not easily departed to cause shut down, thus improving the reliability of the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a main body, comprising a disposing space, a plurality of first terminals, and a push element, wherein the first terminals and the push element are located at two sides of the disposing space respectively;
a battery, disposed in the disposing space, comprising a plurality of second terminals, wherein the second terminals are used for contacting the first terminals; and
a back cover, wedging the main body to cover the disposing space, and comprising a bump on a surface towards the disposing space, wherein during the process that the back cover is sliding along a first direction to wedge the main body, the bump pushes the push element, such that the push element pushes the battery to approach the first terminals.

2. The electronic device according to claim 1, wherein the first terminals are elastic sheets.

3. The electronic device according to claim 1, wherein the push element is a cantilever beam, and the bump is used for contacting a free end of the cantilever beam.

4. The electronic device according to claim 3, wherein the push element comprises a wedging bump, the battery further comprises a wedging slot corresponding to the wedging bump, and the wedging bump is disposed at the free end of the cantilever beam.

5. The electronic device according to claim 1, wherein the battery approaches the first terminals along a direction vertical to the first direction.

6. The electronic device according to claim 1, wherein the push element comprises a wedging bump, and the battery further comprises a wedging slot corresponding to the wedging bump.
